(19) United States
(12) Patent Application Publication
(10) Pub. No.: US 2021/0101259 A1
(43) Pub. Date: Apr. 8, 2021

(54) Stabilization Clamp

(71) Applicant: Larry A. Stroschein, JR., Mandan, ND (US)

(72) Inventor: Larry A. Stroschein, JR., Mandan, ND (US)

(21) Appl. No.: 16/591,050

(22) Filed: Oct. 2, 2019

(51) Int. Cl. B25B 5/14; B25B 5/04; B25B 5/16

(52) U.S. Cl. CPC B25B 5/147; B25B 5/16; B25B 5/04

(57) ABSTRACT

A stabilization clamp for stabilizing and holding fire hydrants or other vertical members, riser pipes, etc., during installation. The stabilization clamp includes a pair of jaws (or other means for holding a vertical member) adapted to securely hold a vertical member, a pivot assembly having a first end and a second end and a pivot between the first end and the second end, the pivot assembly being connected to the jaws at the first end and to a pair of legs at a second end, and an anchor attached to a distal end of each leg. The legs are positionable such that when the distal ends of the legs are spaced apart from each other and anchored, the pivot assembly causes the jaws to close and hold the vertical member in a fixed position.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a stabilization clamp for holding and stabilizing the position of vertical pipes or fire hydrants during installation.

### Related Art

Any discussion of the related art throughout the specification should in no way be considered as an admission that such related art is widely known or forms part of common general knowledge in the field.

During installation of fire hydrants, it is important that the hydrant and the riser it is mounted on to be vertical, as crooked hydrants are unsightly and can make the hook up by the fire department more difficult. Properly installed fire hydrants can also make the maintenance of a city's fire hydrants more cost effective. Fire hydrants and other vertical members or pipes may need to be stabilized, and held in position firmly and accurately during installation, until the excavated hole is sufficiently backfilled to hold the lower barrel of the fire hydrant in place.

In the past, installers sometimes used wooden frames made on site using, for example, 2×4s nailed together, the frame being made in an attempt to hold the fire hydrant in place while it was suspended from a cable being held by an excavator. Such frames may have been assembled, at least partially, by a worker or workers hanging over, or reaching over, the hole in which the hydrant was being installed, thus creating a potentially unsafe work condition for the installers. The variable nature of this installation method didn't allow for a consistent, accurate, or safe installation.

Another possible installation method that has been used is to simply manually hold the hydrant in place while fill material, such as dirt, is placed around the lower barrel of the hydrant, then adjusting the position and packing the soil. This installation procedure rarely results in a good vertical alignment or safe installation of the fire hydrant. Still other methods have involved using short pieces of wood or pipe wedged against the side of the ditch to attempt to maintain the vertical alignment during the backfill process. This method also results in inconsistent installations, and rarely results in accurate vertical alignment of the fire hydrant. Further, this method may not allow for adjustment of the vertical position in multiple directions, which may limit its usefulness.

Accordingly, a device that is more consistent, more accurate, safe, and that speeds up the installation time is desirable.

### SUMMARY

An example embodiment is directed to a stabilization clamp. The stabilization clamp may be used to stabilize and hold fire hydrants or other vertical members, riser pipes, etc., during installation. The stabilization clamp includes a pair of jaws (or other means for holding a vertical member) adapted to securely hold a vertical member, a pivot assembly having a first end and a second end and a pivot between the first end and the second end, the pivot assembly being connected to the jaws at the first end and to a pair of legs at a second end, and an anchor attached to a distal end of each leg. The legs are positionable such that when the distal ends of the legs are spaced apart from each other and anchored, the pivot assembly causes the jaws to close and hold the vertical member in a fixed position.

In some example embodiments, the pair of jaws may include a first jaw element and a second jaw element. Further, the pivot assembly may include a first pivot element and a second pivot element, and the first pivot element may be connected to the first jaw element and the second pivot element may be connected to the second jaw element. The first jaw element and the second jaw element may be curved such that the jaws can secure a cylindrical portion of a vertical member. The clamp may further comprise a plurality of spacers attached to the inside of the first jaw element and the second jaw element. The pair of legs comprises a first leg and a second leg, and the first pivot element is connected to the first leg and the second pivot element is connected to the second leg.

The clamp has a closed position and an open position, wherein the jaws, the pivot elements, and the legs are connected about the pivot such that spreading the legs apart moves the jaws from the open position to the closed position.

In some example embodiments, each leg comprises a leg extension adapted to slidably extend the length of each leg, wherein each anchor is attached to a leg extension. Typically, each leg extension is lockable at a plurality of positions, such that the length of each leg can be varied or adjusted, and then locked in position.

The stabilization clamp may be used by moving the jaws to the open position by moving the legs toward each other, positioning the jaws over the vertical member, closing the jaws by moving the legs away from each other, positioning the vertical member in a first direction anchoring the distal ends of the legs to a surface, positioning the vertical member in a second direction, and then locking the leg extensions at a fixed length to maintain the position of the vertical member.

As mentioned, the vertical member may comprise a fire hydrant, and further, positioning the jaws over the vertical member may comprise positioning the jaws on the barrel of the fire hydrant. In addition, positioning the vertical member in the first direction can comprise positioning the vertical member to be plumb in the first direction. Similarly, positioning the vertical member in the second direction may comprise positioning the vertical member to be plumb in the second direction.

There has thus been outlined, rather broadly, some of the embodiments of the Stabilization clamp in order that the detailed description thereof may be better understood, and in order that the present contribution to the art may be better appreciated. There are additional embodiments of the stabilization clamp that will be described hereinafter and that will form the subject matter of the claims appended hereto. In this respect, before explaining at least one embodiment of the stabilization clamp in detail, it is to be understood that the stabilization clamp is not limited in its application to the details of construction or to the arrangements of the components set forth in the following description or illustrated in the drawings. The stabilization clamp is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a stabilization clamp in accordance with an example embodiment.

FIG. 2 is another perspective view of a stabilization clamp in accordance with an example embodiment.

FIG. 3 is another perspective view of a stabilization clamp in accordance with an example embodiment.

FIG. 4 is a detail perspective view of a stabilization clamp in accordance with an example embodiment.

FIG. 5 is another detail, perspective view of a stabilization clamp in accordance with an example embodiment.

FIG. 6 is another detail, perspective view of a stabilization clamp in accordance with an example embodiment.

FIG. 7 is a perspective view of a fire hydrant on which a stabilization clamp in accordance with an example embodiment may be used.

FIG. 8 is a top view of a fire hydrant on which a stabilization clamp in accordance with an example embodiment may be used.

FIG. 9 is a perspective view of a stabilization clamp in accordance with an example embodiment being used.

FIG. 10 is another perspective view of a stabilization clamp in accordance with an example embodiment being used.

FIG. 11 is another perspective view of a stabilization clamp in accordance with an example embodiment being used.

FIG. 12 is a top view of a stabilization clamp in accordance with an example embodiment.

FIG. 13 is another top view of a stabilization clamp in accordance with an example embodiment.

FIG. 14 is a simplified, representative flowchart in accordance with one example embodiment of the method.

### DETAILED DESCRIPTION

### A. Overview

An example stabilization clamp 10 generally comprises a pair of jaws 20 (or other means for holding a vertical member) adapted to securely hold a vertical member, such as a fire hydrant 70, during installation. The clamp 10 may also include a pivot assembly 30 having a first end 36 and a second end 38, and a pivot 32 between the first end 36 and the second end 38, the pivot assembly 30 being connected to the jaws 20 at the first end 36 and to a pair of legs 40 at the second end 38, and an anchor 50 attached to a distal end 42 of each leg. The legs 40 are positionable such that when the distal ends 42 of the legs 40 are spaced apart from each other and anchored, the pivot assembly 30 causes the jaws 20 to close and hold the vertical member in a fixed position.

The pair of jaws 20 may include a first jaw element 21 and a second jaw element 23. Further, the pivot assembly 30 may include a first pivot element 31 and a second pivot element 33, and the first pivot element 31 may be connected to the first jaw element 21 and the second pivot element 33 may be connected to the second jaw element 23. The first jaw element 21 and the second jaw element 23 may be curved such that the jaws can secure a cylindrical portion of a vertical member 70. The clamp 10 may further comprise a plurality of spacers 22 attached with fasteners 24 to the inside of the first jaw element 21 and the second jaw element 23. The pair of legs 40 comprises a first leg element 43 and a second leg element 45, and the first pivot element 31 is connected to the first leg 43 and the second pivot element 33 is connected to the second leg element 45.

Although other materials are possible, the clamp 10 may be made of steel or alloy, such that the components described herein may be welded, bolted, or screwed together, or attached by other suitable means. As an example, the pivot elements can be made in a shape that closely matches the jaws, so that the two components can be welded together at attachment 28.

The clamp 10 has a closed position and an open position, wherein the jaw elements 21, 23, the pivot elements 31, 33, and the leg elements 43, 45 are connected about the pivot 32 (which may be a nut and bolt) such that spreading the legs apart moves the clamp 10 from the open position to the closed position. In some example embodiments, each leg element 43, 45 comprises a leg extension 48 adapted to slidably extend the length of each leg, wherein each anchor 50 is attached to a leg extension 48. Typically, each leg extension 48 is lockable at a plurality of positions by a set screw 46, such that the length of legs 40 can be varied or adjusted, and then locked in position.

### B. Jaws

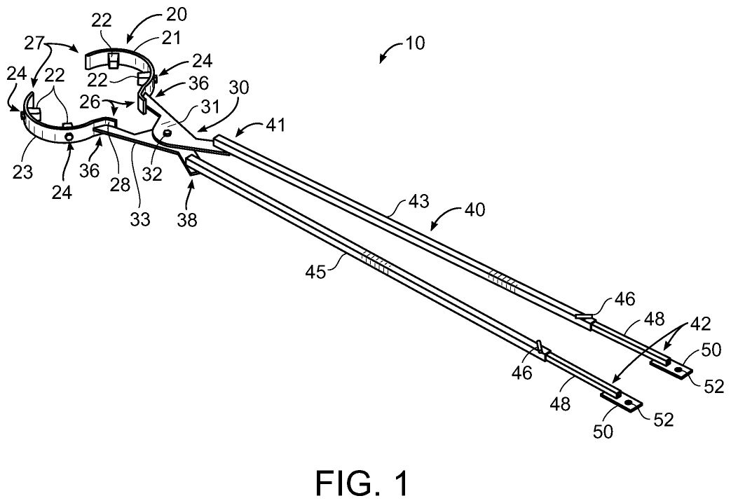

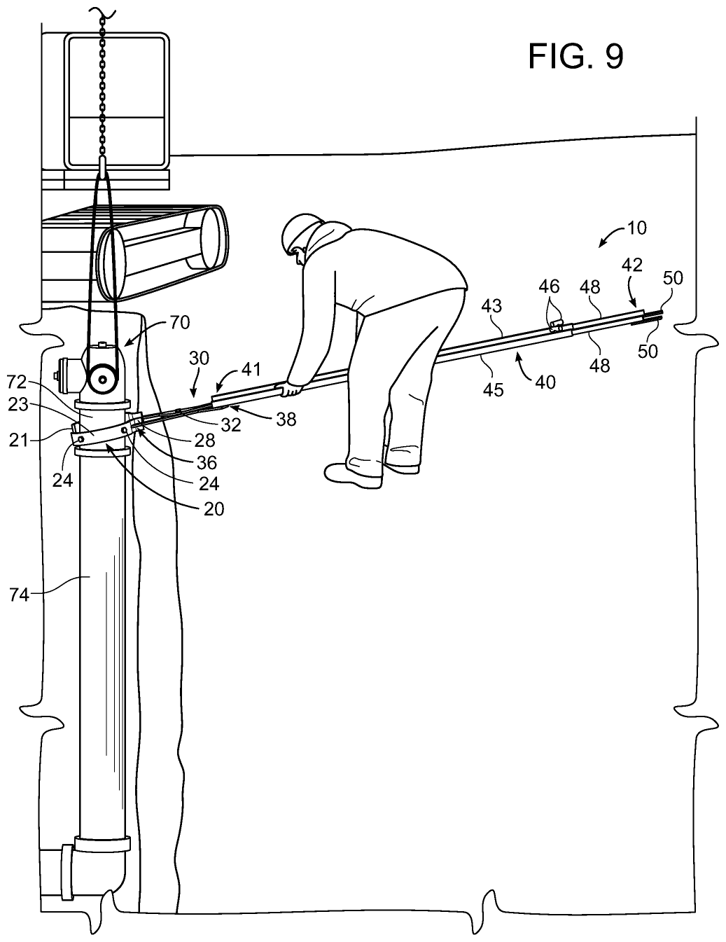

As mentioned above, the clamp 10 may comprise a pair of jaws 20, comprising first jaw element 21 and second jaw element 23, as shown in FIGS. 1-4. The jaws may be adapted to securely fit on, and hold, a cylindrical shape, such as the upper barrel 72 of a fire hydrant 70, or any other vertical member, pipe, etc. Typically, during installation, a fire hydrant 70 is mounted on a water main, as shown in FIGS. 9-11. Thus, the bottom flange of the hydrant 70 is maintained by its mounting at a fixed height above the water main, so that the clamp 10 does not need to support the upper portion of hydrant 70 in the vertical direction, but only needs to stabilize its position in the horizontal direction.

In order to better fit a cylindrical shape, the jaws 20 may be curved, and further, may be curved so that the inside of each jaw element 21, 23, may be substantially circular or shaped to form a section of a circle, although the jaws in the closed position need not form a complete circle. In other embodiments, the jaws may not be curved, but may have inserts, such as spacers 22 or other inserts (e.g., with different sizes and shapes) to allow the jaws 20 to fit not only cylindrical objects, but objects of different shapes as well. As an example, the jaws 20 may be straight or substantially straight, and may use inserts in order to fit on a cylindrical object, such as a fire hydrant 70.

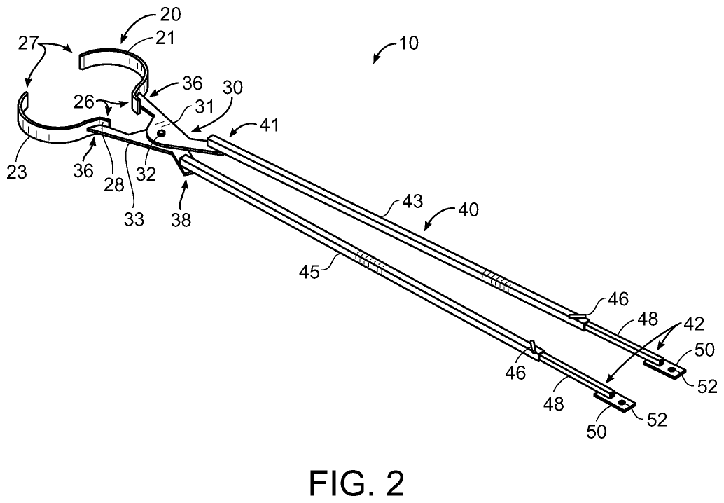

As mentioned, the spacers 22 are optional and removable, being attached to the jaws with fasteners 24. FIG. 2 illustrates an embodiment of the clamp 10 without spacers. In addition to accommodating different shapes, the spacers allow for the clamp 10 to be used with different sized hydrants or other vertical members. For example, without spacers 22 installed, the clamp 10 can be used for clamping and stabilizing a larger diameter hydrant, pipe, etc.

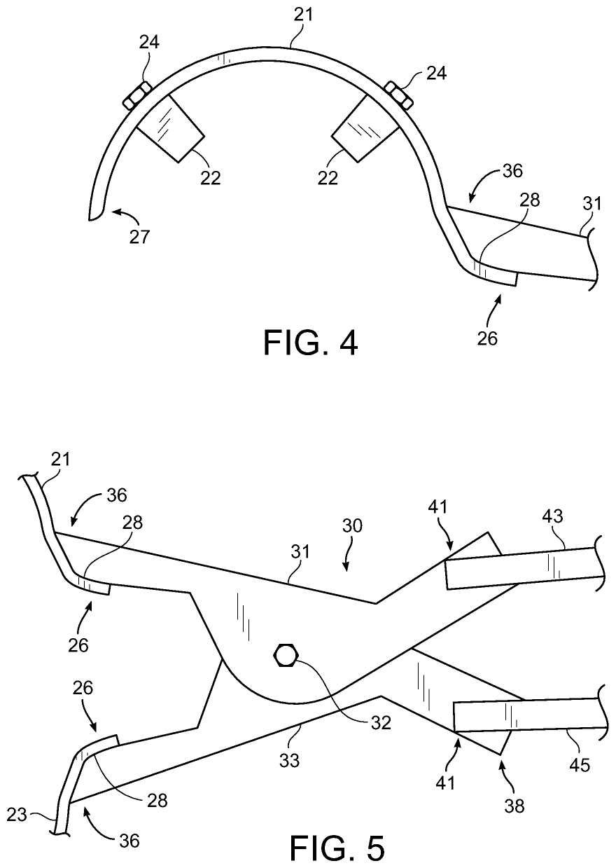

As best shown in FIGS. 4 and 5, each jaw may have a first end 26, shaped to mate with, and be attached to, a pivot element 31 or 33, and may, for example, be welded or otherwise attached or formed on a pivot element 31, 33 at an attachment point 28. The clamp 10 is designed so that when the legs 40 are moved close together, the second ends 27 of the jaws 20 are far enough apart that the clamp 10 can be moved into position over the barrel of a fire hydrant 70, without being lowered onto the hydrant 70 over the top.

### C. Pivot Assembly

The clamp 10 may also comprise a pivot assembly 30, which may be made of two similar or identical pivot elements 31 and 33, pivotally held together by pivot 32. As shown in FIG. 5, the pivot elements 31, 33 may be flat or mostly flat (although other shapes are possible), so that their mating surfaces guide and stabilize each other and the clamp 10 overall. As also shown in the figures, the pivot elements 31, 33 attach at a first end of the assembly 36 to the jaw elements 21, 23, respectively, and to legs 40 (i.e., telescoping legs) at the second end 38 of the pivot assembly 30.

Unlike a pair of pliers or similar tool or device, the pivot assembly 30 comprises a pivot element 31 or 33 which is attached to a jaw element or a leg on the same side of the pivot 32, which may comprise a nut and bolt. This configuration “reverses” the action of the clamp, such that opening the legs 40, which act as levers, closes the clamp 10, so that the jaws 20 clamp a fire hydrant 70. This is a desirable action because spreading the legs 40 of the clamp 10 allows the distal ends 42 of the legs to be staked to the ground or another surface relatively far apart, which better stabilizes the position of the clamp and the clamped hydrant 70. For ease of assembly and manufacturing, each pivot element 31, 33 may be identical or similar.

As can be seen from the figures generally, the relatively long legs 40, which have ends 41 attached to the second ends 38 of the pivot elements 31, 33, provides leverage and clamping power sufficient to hold the fire hydrant 70 or other element in place.

### D. Telescoping Legs

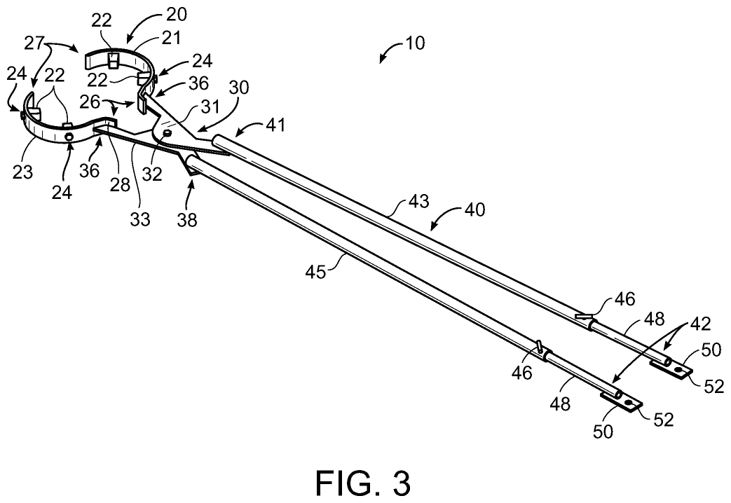

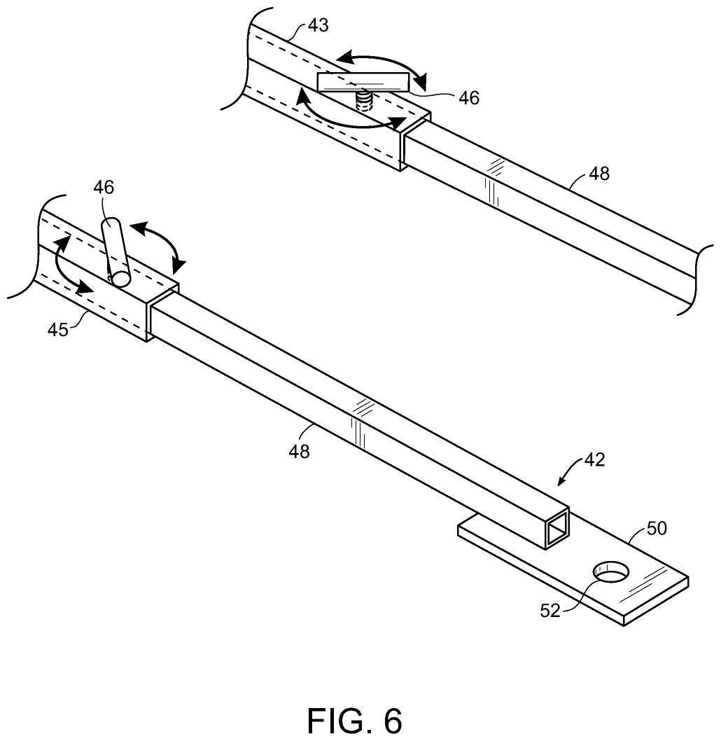

The clamp 10 may also have a pair of elongated legs 40, which may be telescoping legs. Accordingly, they may include extensions 48 that are designed to slide in and out of the individual leg elements 43, 45. In the embodiments shown, the legs 40 comprise square or round tubes, with extensions 48 being sized to fit inside of the leg elements 43 and 45. Other shapes and configurations are also possible. For example, round tubes, as shown in FIG. 3, may be used for the legs 40, and especially for extensions 48, if necessary, in order to accommodate uneven ground at the installation site. Specifically, if round tubes are used, the extensions 48 can be rotated within leg elements 43 and 45 so that the anchors 50 need not be on flat, level ground. The length of the legs 40 can be adjusted by loosening set screws 46, as shown in FIG. 6, and sliding the extensions 48 in or out of leg elements 43, 45.

As best shown in FIGS. 1-3, the legs 40 have a first end 41 and a distal end 42, away from the jaws 20. Attached to or formed on the distal ends 42 are anchors 50, which may be in the form of flat plates, flanges, etc. with holes 52, usable for anchoring the distal ends 42 of the legs 40 to the ground, as discussed in further detail below.

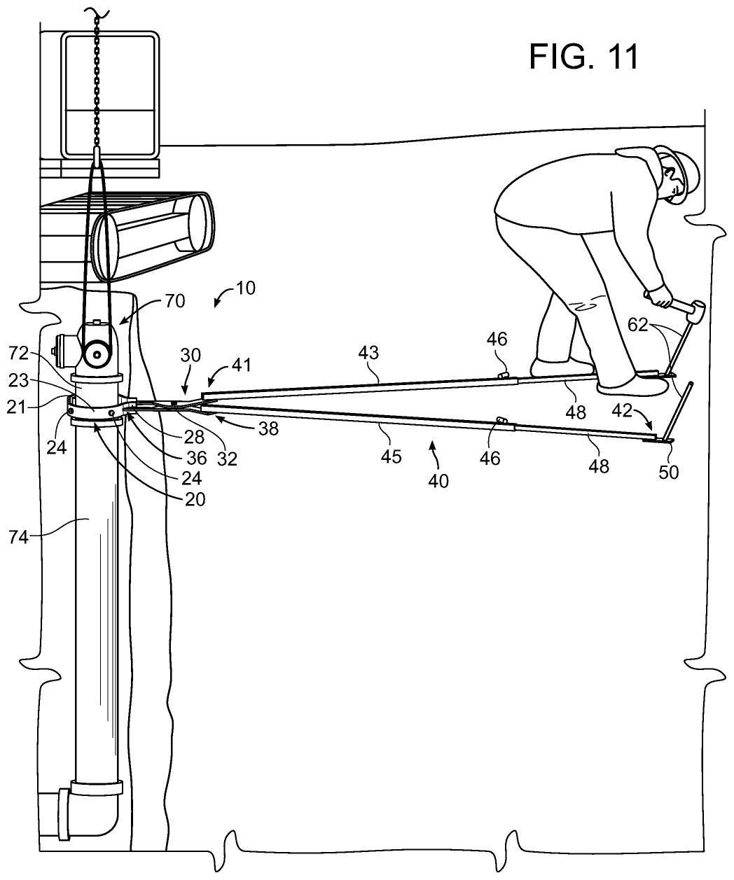

The relatively long legs 40 of the clamp 10 provide leverage and clamping force to the jaws 20, and they also make the clamp's position very stable when the distal ends 42 of the legs are staked in place using stakes 62, as shown in FIG. 11.

### E. Operation of Preferred Embodiment

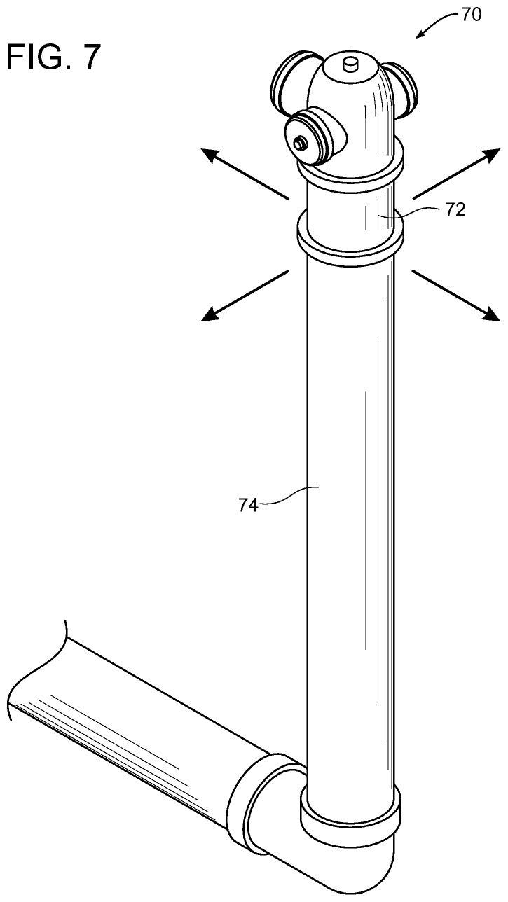

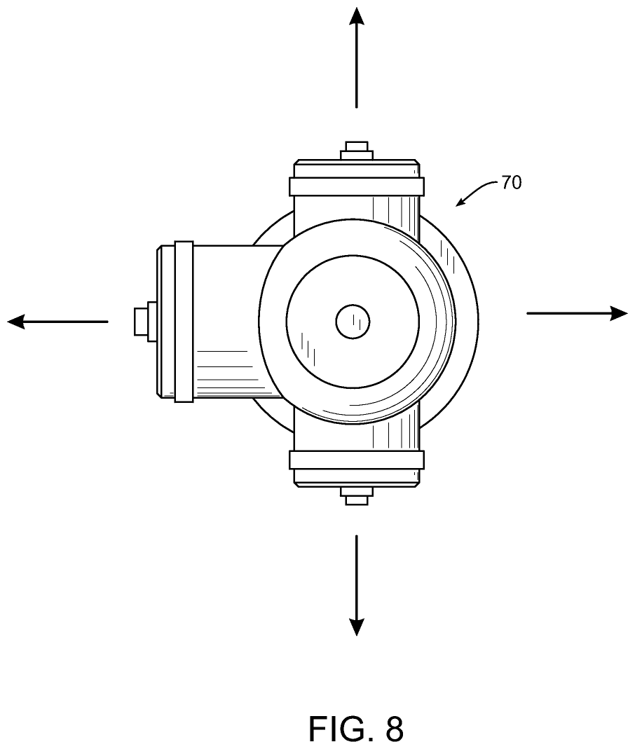

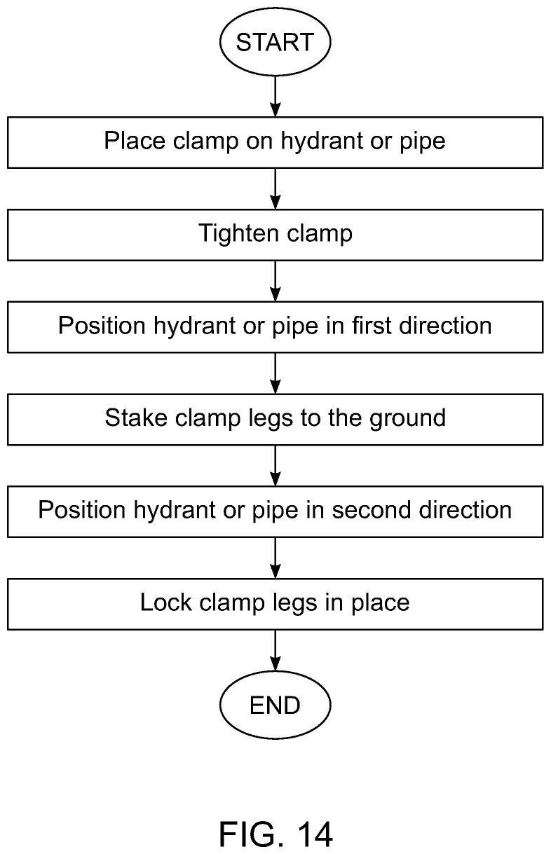

The steps for using the stabilization clamp 10 are outlined broadly in FIG. 14. Before the clamp is used, a fire hydrant 70 is typically lowered into an excavated hole, suspended by a cable from an excavator crane, or other apparatus. Once lowered, it is attached to a municipal water line. This attachment is not overly rigid, however, and allows the fire hydrant 70 to be moved, such that the top of the hydrant 70 moves in a substantially horizontal plane, as indicated by the arrows in FIGS. 7 and 8. Rather than just the attachment to the water line, it is the dirt or other material that is replaced in the hole or ditch that holds the fire hydrant in position—thus the need for the stabilization clamp 10, since it is possible for the hydrant 70 to lean in any direction while the hole or excavation is being backfilled.

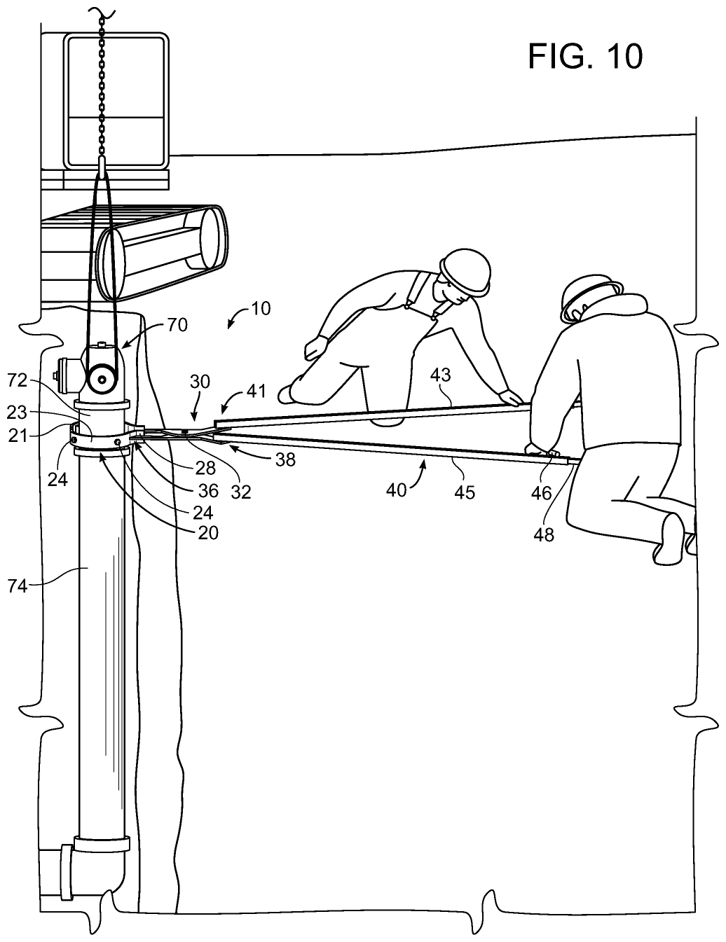

As shown in FIGS. 9 and 10, after the hydrant 70 has been attached to the municipal water line, and while it is still suspended from a cable, its position may be adjusted, preferably so that the lower barrel 74 of the hydrant is plumb. With the hydrant in roughly its final position, the legs 40 are used, typically by one or two workers, to operate the clamp. The workers may do so by first moving the legs 40 together, thus opening the jaws 20 to their open, widest position. The legs 40 may have extensions 48 that allow them to telescope, the purpose of which will be described more fully below.

The workers may initially position the extensions 48 so that they are halfway out of the fixed portion of legs 40, and in this position, the extensions 48 may be locked in place using set screws 46, which may screw into threaded holes or attachments on legs 40.

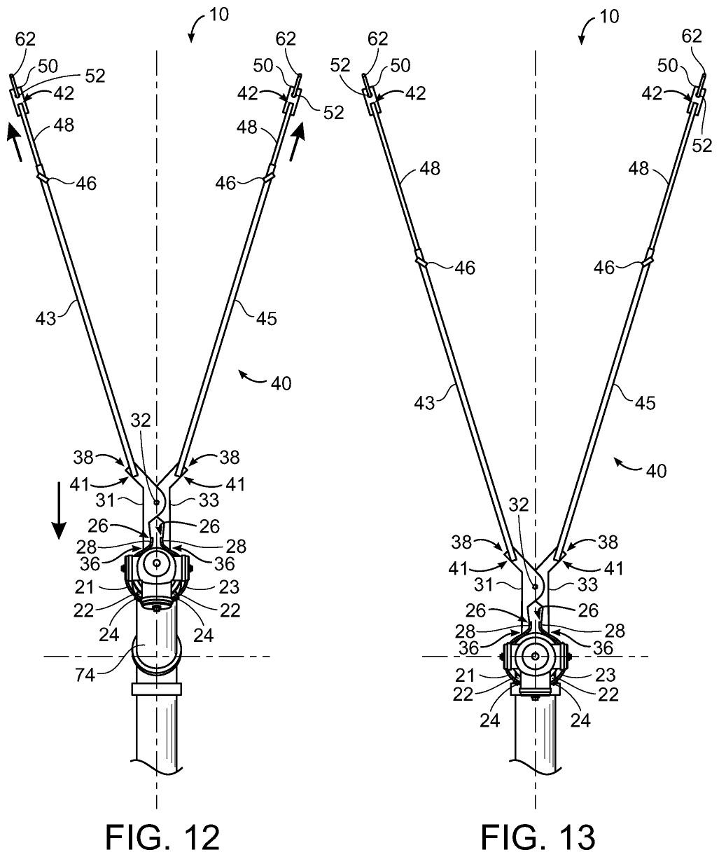

With the legs together, the jaws 20 of the clamp 10 are open, and the clamp can be placed on the upper barrel 72 of fire hydrant 70. Once thus installed, the legs are spread to their widest position, as far apart as the clamp will allow, which closes the jaws 20 of the clamp 10 tightly on the upper barrel 72 of the hydrant 70, typically just above the breakaway flange of the hydrant 70. At this point in the procedure, a worker in the hole may use a level to ensure that the lower barrel 74, between the water main and the hydrant's flange, is plumb in at least a first direction, so that the top of the hydrant is directly above the centerline of the water main, but not necessarily directly above the attachment point to the main, as shown in FIG. 12. In this position, the spread of the legs 40 will tend to keep the hydrant plumb in this first direction. To adjust the position of the hydrant, it may be necessary for an operator to lower the hydrant 70 by increasing the slack in the cable from which the hydrant is suspended.

With the clamp 10 in place and the legs 40 held apart, the distal ends 42 of the legs are positioned on a surface, such as the ground, and staked in place, typically with ¾″ round steel stakes 62 placed in holes 52 of anchors 50 and pounded into the ground. The ends 42 of the legs 40 may be anchored roughly equidistant from a plane passing through the center of the hydrant 70, as best shown in FIG. 12. This placement helps keep the hydrant 70 aligned in the first direction.

Once the ends 42 of legs 40 are anchored to the ground, a worker in the excavation, next to the lower barrel 74 of the fire hydrant 70, can check the plumb of the lower barrel 74 in a second direction, which may be the direction of the water main as shown in FIGS. 12 and 13. For example, in FIG. 12, the lower barrel 74 is plumb in the first direction, but not the second. To adjust the position accordingly, the set screws 46 are loosened and the legs 40 are lengthened (or shortened, as needed) using extensions 48, until the lower barrel 74 is plumb in the second direction, as well as the first direction, as shown in FIG. 13. Once in proper position, the set screws 46 are tightened again, and the fire hydrant 70 will be held in place until the excavation is filled and the installation is complete.

Unless otherwise defined, all technical and scientific terms used herein have the same meaning as commonly understood by one of ordinary skill in the art to which this invention belongs. Although methods and materials similar to or equivalent to those described herein can be used in the practice or testing of the stabilization clamp, suitable methods and materials are described above. All publications, patent applications, patents, and other references mentioned herein are incorporated by reference in their entirety to the extent allowed by applicable law and regulations. The stabilization clamp may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A stabilization clamp, comprising:
a pair of jaws adapted to securely hold a vertical member;
a pivot assembly having a first end and a second end and a pivot between the first end and the second end, the pivot assembly being connected to the jaws at the first end and to a pair of legs at the second end; and
an anchor attached to a distal end of each leg;
wherein the legs are positionable such that when the distal ends of the legs are spaced apart from each other and anchored, the pivot assembly causes the jaws to close and hold the vertical member in a fixed position.

2. The stabilization clamp of claim 1, wherein the pair of jaws comprises a first jaw element and a second jaw element.

3. The stabilization clamp of claim 2, wherein the pivot assembly comprises a first pivot element and a second pivot element, and wherein the first pivot element is connected to the first jaw element and the second pivot element is connected to the second jaw element.

4. The stabilization clamp of claim 3, wherein the pair of legs comprises a first leg and a second leg, and wherein the first pivot element is connected to the first leg and the second pivot element is connected to the second leg.

5. The stabilization clamp of claim 4, wherein the clamp has a closed position and an open position, wherein the jaws, the pivot elements, and the legs are connected about the pivot such that spreading the legs apart moves the clamp from the open position to the closed position.

6. The stabilization clamp of claim 1, wherein the pair of jaws comprises a first jaw element and a second jaw element, and wherein the first jaw element and the second jaw element are curved such that the jaws can secure a cylindrical portion of a vertical member.

7. The stabilization clamp of claim 6, wherein the vertical member comprises a fire hydrant.

8. The stabilization clamp of claim 6, further comprising a plurality of spacers attached to the inside of the first jaw element and the second jaw element.

9. The stabilization clamp of claim 1, wherein each leg comprises a leg extension adapted to slidably extend the length of each leg, wherein each anchor is attached to a leg extension.

10. The stabilization clamp of claim 9, wherein each leg extension is lockable at a plurality of positions, such that the length of each leg can be varied.

11. A method of using the stabilization clamp of claim 9, comprising:
moving the jaws to the open position by moving the legs toward each other;
positioning the jaws over the vertical member;
closing the jaws by moving the legs away from each other;
positioning the vertical member in a first direction;
anchoring the distal ends of the legs to a surface;
positioning the vertical member in a second direction; and
locking the leg extensions at a fixed length to maintain the position of the vertical member.

12. The method of claim 11, wherein the vertical member comprises a fire hydrant.

13. The method of claim 12, wherein positioning the jaws over the vertical member comprises positioning the jaws on a barrel of the fire hydrant.

14. The method of claim 11, wherein positioning the vertical member in the first direction comprises positioning the vertical member to be plumb in the first direction.

15. The method of claim 11, wherein positioning the vertical member in the second direction comprises positioning the vertical member to be plumb in the second direction.

16. The method of claim 11, wherein positioning the vertical member in the first direction comprises positioning the vertical member to be plumb in the first direction, and wherein positioning the vertical member in the second direction comprises positioning the vertical member to be plumb in the second direction.

17. A stabilization clamp, comprising:
means for holding a vertical member;
a pivot assembly having a first end and a second end and a pivot between the first end and the second end, the pivot assembly being connected to the means for holding at the first end and to a pair of legs at the second end; and
means for anchoring a distal end of each leg;
wherein the legs are positionable such that when the distal ends of the legs are spaced apart from each other and anchored, the pivot assembly causes the means for holding to hold the vertical member in a fixed position.

18. The stabilization clamp of claim 17, wherein the pivot assembly comprises a first pivot element and a second pivot element, and wherein the first pivot element is connected to the first jaw element and the second pivot element is connected to the second jaw element.

19. The stabilization clamp of claim 18, wherein the pair of legs comprises a first leg and a second leg, and wherein the first pivot element is connected to the first leg and the second pivot element is connected to the second leg.

20. The stabilization clamp of claim 19, wherein the clamp has a closed position and an open position, wherein the jaws, the pivot elements, and the legs are connected about the pivot such that spreading the legs apart moves the clamp from the open position to the closed position.
